(19) United States
(12) Patent Application Publication
(10) Pub. No.: US 2013/0082032 A1
(43) Pub. Date: Apr. 4, 2013

(54) NOSE OF SINGLE-AIR-HOLE ELECTRICAL ARC SPRAY MACHINE

(71) Applicant: SHEN'S GLORY INC., Taipei City (TW)

(72) Inventor: Wu-Fang SHEN, Taipei City (TW)

(73) Assignee: SHEN'S GLORY INC., Taipei City (TW)

(21) Appl. No.: 13/624,973

(22) Filed: Sep. 24, 2012

(30) Foreign Application Priority Data
Sep. 29, 2011 (TW) 100135121

(51) Int. Cl. B23K 9/04

(52) U.S. Cl. 219/76.14

(57) ABSTRACT

A nose of single-air-hole electrical arc spray machine includes a nozzle body that forms an air flow hole and two guide tube holes arranged at opposite sides of the air flow hole and forming a predetermined angle with respect thereto, a nozzle ring positioned against and fixed to the nozzle body, an electrical discharging chamber internal lid positioned against the nozzle ring, an electrical discharging chamber external cover enclosing the electrical discharging chamber internal lid, an external mounting ring mounting the electrical discharging chamber internal lid and the electrical discharging chamber external cover to the nozzle body, and wire guide tubes. Each of the wire guide tubes includes an insulation section, a conductor section, and a wire emergence terminal sequentially connected to each other. The nose is durable and is easy to maintain with a reduced maintenance cost and improves void ratio of a sprayed layer of coating formed thereby.

### TECHNICAL FIELD OF THE INVENTION

The present invention generally relates to thermal spray equipment, and more particularly to a nose of single-air-hole electrical arc spray machine.

### DESCRIPTION OF THE PRIOR ART

Thermal spray equipment is a surface treatment device for components, which is capable of spraying different coatings on the surfaces of components according to different purposes in order to improve the capability of erosion resistance, corrosion resistance, abrasion resistance, insulation, thermal isolation, and electromagnetic interference protection.

Various thermal spray equipment having different characteristics are known and users may select the desired one according his or her needs. For example, flame spray uses a flame formed by burning a mixture of oxygen and gaseous fuel as a heat source to melt a spray material, which then driven and accelerated by compressed air toward the surface of a base material to accumulate and solidify thereon to form a layer of coating or a thick film. Electrical arc spray uses two metal wires that are connected to different electrodes to generate electrical arc through mutual contact therebetween so as to instantaneously generate a high temperature that melts the metal wires, followed by atomization and nebulization by compressed air to be blown toward the base material, and accumulate and solidify thereon to form a layer of coating or a thick film.

High velocity oxy-fuel (HVOF) makes use of non-stable flaming caused by an increase of oxygen-fuel ratio to form a front shock wave whereby impact can be made on molten powders by ultrasonic waves to have them accumulated and solidified on the surface of a base material to form a layer of coating or a thick film. Plasma spray uses a high temperature generated by ionized gas (such as argon, hydrogen, nitrogen, and helium) as a heat source to melt powder-like spray material, followed by blowing with gas to accumulate and solidify and thus form a layer of coating or a thick film.

The above discussed approaches of thermal spray equipment are of different advantages in respect of bonding strength and void ratio of the sprayed coating layer. However; since the surface treatment temperature often reaches a level as high as two thousands degrees Celsius, which is not fit for 3C products. Although the spraying temperature of the known thermal electrical arc spray devices can be as low as 80 degrees Celsius, yet this is still an excessively high temperature for 3C products. Taiwan Patent No. I343838 proposes a nose of low temperature thermal spray machine that is capable of performing ultra-low temperature surface treatment spraying operation with improved bonding strength and void ratio for the sprayed layer of coating formed thereby. However, it is disadvantageous in that the maintenance is high and the void ratio of the sprayed layer of coating may be further improved.

### SUMMARY OF THE INVENTION

In view of these problems, an object of the present invention is to provide a nose of single-air-hole electrical arc spray machine, which, besides being durable and easy to maintain to thereby reduce the maintenance cost, may further improve the void ratio of the sprayed layer of coating.

To achieve the above object and other objects, the present invention provides a nose of single-air-hole electrical arc spray machine, which comprises a nozzle body, a nozzle ring, an electrical discharging chamber internal lid, an electrical discharging chamber external cover, an external mounting ring, and the wire guide tubes.

The nozzle body forms an air flow hole and two guide tube holes that are respectively located at opposite sides of the air flow hole and form a predetermined angle with respect thereto. The air flow hole has an inlet end and an outlet end. The nozzle ring is positioned against and fixed to an end face of the outlet end and forms a through opening corresponding to the air flow hole and the two guide tube holes. The electrical discharging chamber internal lid is positioned against the nozzle ring and forms an internal lid through opening corresponding to the through opening. The electrical discharging chamber external cover is set to cover and enclose the electrical discharging chamber internal lid, whereby the electrical discharging chamber internal lid and the electrical discharging chamber external cover form therebetween an electrical arc discharging chamber. The external mounting ring is coupled to the nozzle ring to mount the electrical discharging chamber internal lid and the electrical discharging chamber external cover to the outlet end of the nozzle body. The wire guide tubes are respectively received in the two guide tube holes to extend to locations adjacent to the electrical arc discharging chamber and are each composed of an insulation section, a conductor section, and a wire emergence terminal that sequentially connected to each other.

In an embodiment, the nozzle body of the nose of single-air-hole electrical arc spray machine is integrally formed of Bakelite.

In an embodiment, the insulation sections of the wire guide tubes of nose of single-air-hole electrical arc spray machine are made of Teflon and the conductor sections and the wire emergence terminals are made of copper. The insulation sections that are made of Teflon are helpful to protecting an operator from electrical shocks. The wire emergence terminals that are made of copper allow the wire emergence terminals to be individually replaced when the wire guide tubes are worn out due to spraying temperature so as to greatly reduce the maintenance cost of the nose of single-air-hole electrical arc spray machine.

In an embodiment, the electrical discharging chamber internal lid of the nose of single-air-hole electrical arc spray machine is made of Bakelite and the electrical discharging chamber external cover, the nozzle ring, and the external mounting ring are made of aluminum alloys. The nozzle ring that is made of an aluminum alloy is positioned against an end face of the outlet end of the nozzle body to isolate the nozzle body and the electrical arc discharging chamber from each other so as to protect the nozzle body from deterioration caused by the heat generated by the electrical arc discharging chamber.

In an embodiment, the nose of single-air-hole electrical arc spray machine further comprises an aluminum alloy fixing plate that is fixed to the nozzle body to facilitate assembling to a handle of the nose. The predetermined angle formed by the two guide tube holes of the nozzle body is preferably between 25 to 35 degrees.

The above described nose of single-air-hole electrical arc spray machine is easy to maintain, is durable, and greatly reduces the maintenance cost and may further provide the following advantages:

(1) The electrical arc spray machine may maintain surface treatment temperature between 9 to 40 degrees Celsius so as to be applicable to surface treatment operation of 3C products.

(2) The electrical arc spray machine may form a sprayed coating layer that has improved bonding strength of at least 150 kgf/cm2.

(3) The electrical arc spray machine may form a sprayed coating layer having a void ratio that is lowered down to 0.5%-4.5% so as to provide a finer sprayed coating layer.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a nose of single-air-hole electrical arc spray machine according to a preferred embodiment of the present invention in an assembled form.

FIG. 2 is an exploded view showing the nose of FIG. 1.

FIG. 3 is a vertically sectioned view of the nose shown in FIG. 1.

FIG. 4 is a horizontally sectioned view of the nose shown in FIG. 1.

FIG. 5 is a perspective view of a nozzle ring shown in FIG. 2 but taken from a different angle.

FIG. 6 is a perspective view of an electrical discharging chamber internal lid shown in FIG. 2 but taken from a different angle.

FIG. 7 is a perspective view of an electrical discharging chamber external lid shown in FIG. 2 but taken from a different angle.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

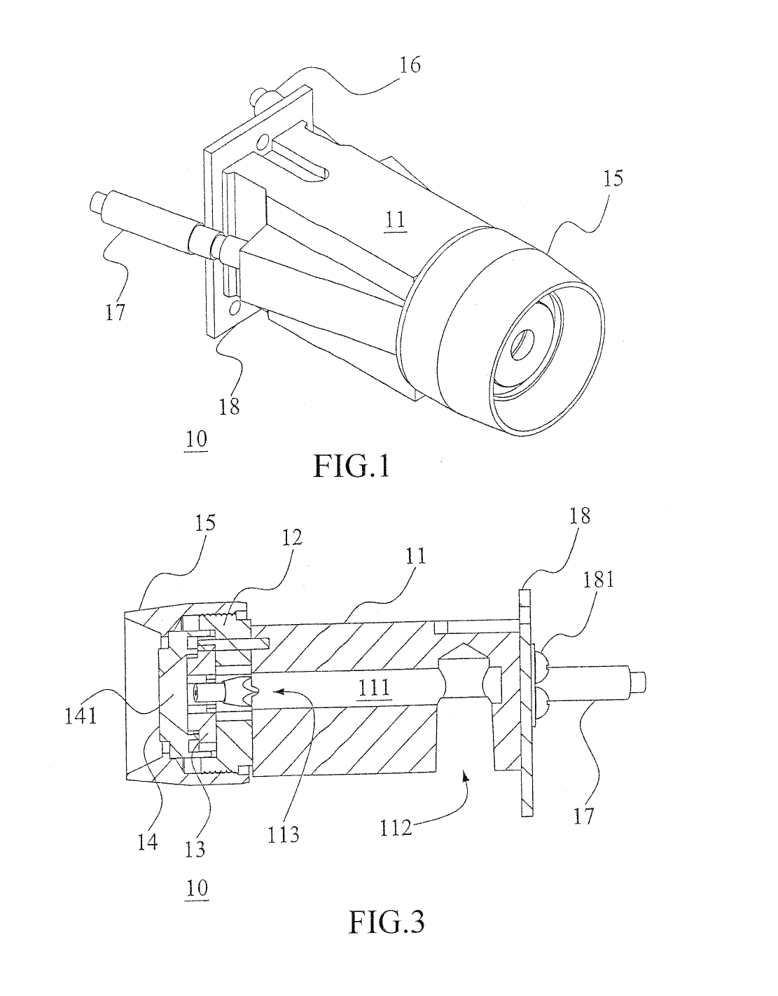

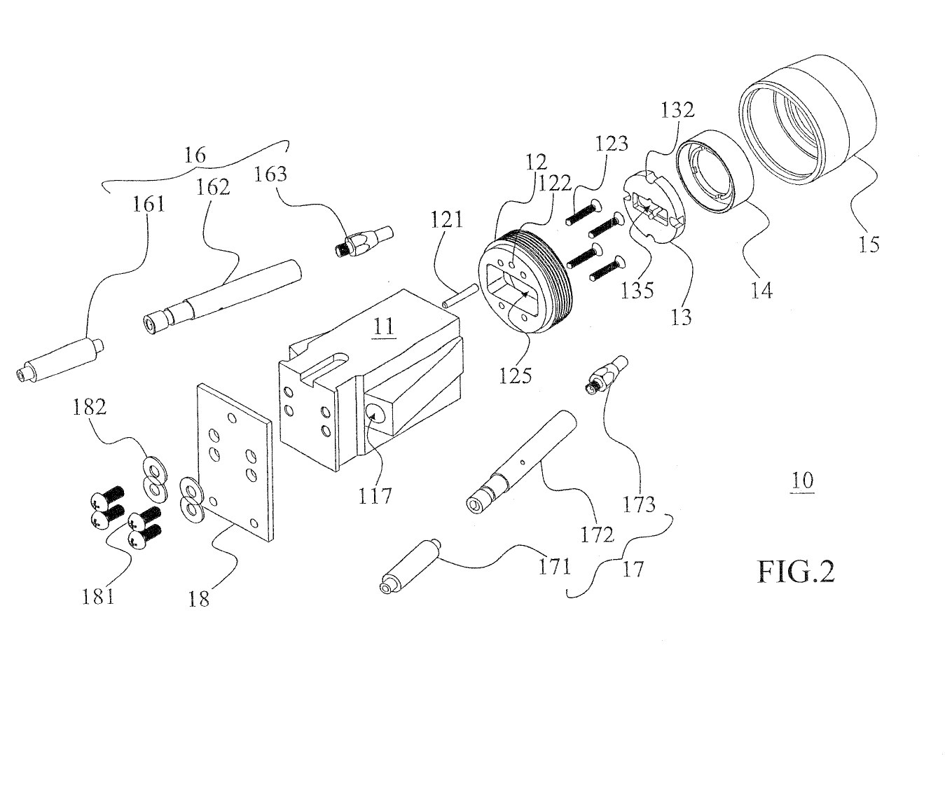

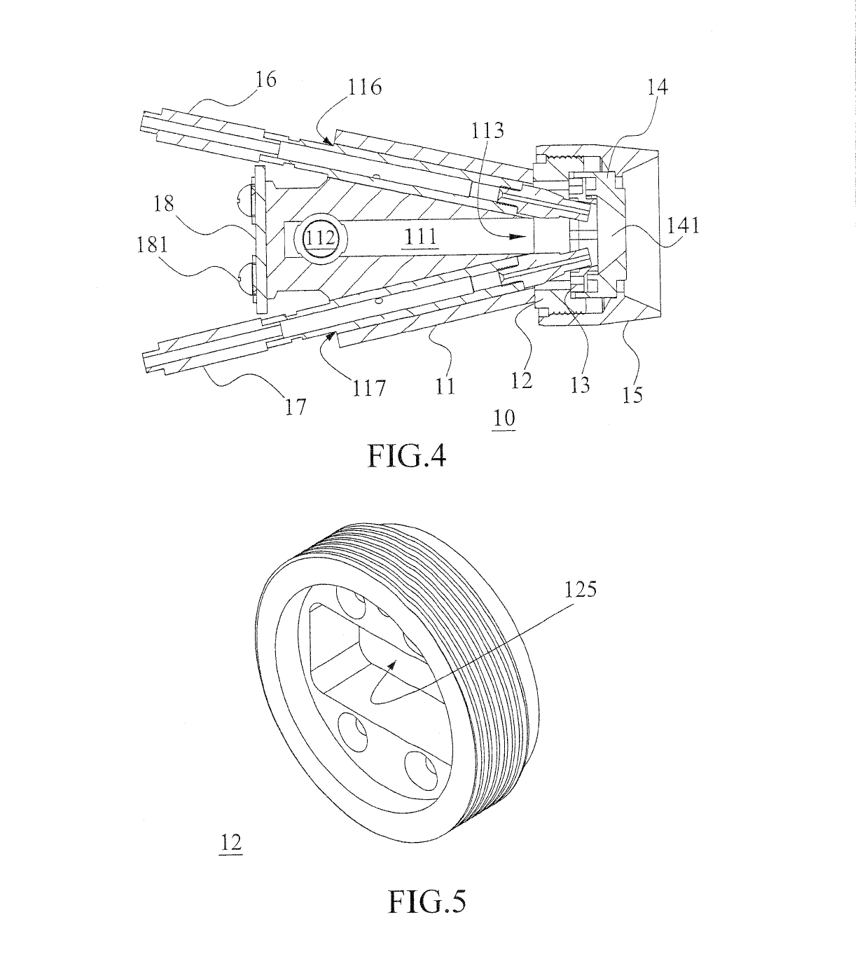

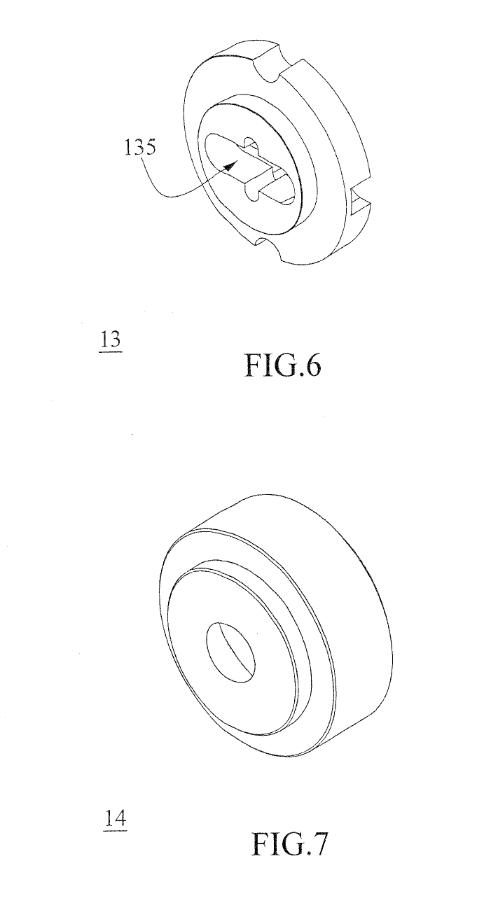

Referring to FIGS. 1-7, which are various views illustrating a nose of single-air-hole electrical arc spray machine according to a preferred embodiment of the present invention, as shown in the drawings, the present invention provides a nose of single-air-hole electrical arc spray machine, generally designated at 10, which comprises a nozzle body 11, a nozzle ring 12, an electrical discharging chamber internal lid 13, an electrical discharging chamber external cover 14, an external mounting ring 15, wire guide tubes 16, 17 and an aluminum alloy fixing plate 18. The aluminum alloy fixing plate 18 functions to attach the single-air-hole electrical arc spray machine nose 10 to an operating handle (not shown) of the electrical arc spray machine to allow an operator to handle. Thus, in assembling, screws 181 and washers 182 are used to fix the aluminum alloy fixing plate 18 to a rear side of the nozzle body 11.

In the drawings, the wire guide tubes 16, 17 are each composed of an insulation section 161, 171, a conductor section 162, 172, and a wire emergence terminal 163, 173 that are sequentially connected and form through holes for wires. The insulation section 161, 171 is made of an insulation material, such as Teflon, to prevent an operator from contacting the conductor section 162, 172 that is made of copper in doing an operation so as to protect the operator against the risk of electrical shock. The wire emergence terminal 163, 173, which is made of for example copper, allows the wire emergence terminal 16, 17 to be individually replaced when the wire guide tube 16, 17 wears out due to the spraying temperature so as to greatly reduce the maintenance cost of the single-air-hole electrical arc spray machine nose 10.

The nozzle body 11 forms an air flow hole 111 and two guide tube holes 116, 117 that are respectively located at opposite sides of the air flow hole 111 and form a predetermined angle with respect thereto. The air flow hole 111 has an inlet end 112 into which compressed air from an air compressor (not shown) is conducted and an outlet end 113. The predetermined angle formed by the two guide tube holes 116, 117 with respect to the nozzle body 11 is preferably between 25 to 35 degrees.

The nozzle ring 12 is positioned against an end face of the outlet end 113 of the nozzle body 11 with alignment being made by a positioning pin 121 mating positioning holes 122 formed in both the nozzle body 11 and the nozzle ring 12. Afterwards, screws 123 are set to fix the nozzle ring to the nozzle body 11. The nozzle ring 12 forms a through opening 125 corresponding to the air flow hole 111 and the two guide tube holes 116, 117 to serve as an extended space for the wire guide tubes 16, 17 and provides a passage for compressed air that is introduced through the air flow hole 111.

The electrical discharging chamber internal lid 13 is positioned against the nozzle ring 12 by having a positioning hole 132 thereof aligning the positioning pin 121 and forms an internal lid through opening 135 that corresponds to the through opening 125 of the nozzle ring 12. The internal lid through opening 135 also serves as an extended space for the wire guide tubes 16, 17 and provides a passage for compressed air that is introduced through the air flow hole 111. The electrical discharging chamber external cover 14 is set to cover and enclose the electrical discharging chamber internal lid 13, whereby the electrical discharging chamber internal lid 13 and electrical discharging chamber external cover 14 form therebetween an electrical arc discharging chamber 141, which provides a space for electrical arc discharging carried out with metal wires that are received through wire holes defined in the wire guide tubes 16, 17 and is driven to move forward by a driving mechanism, such as pneumatic motor.

The external mounting ring 15 has an internal thread that is engageable with an external thread form on the nozzle ring 12 to mount the electrical discharging chamber internal lid 13 and the electrical discharging chamber external cover 14 to the outlet end 113 of the nozzle body 11. The wire guide tubes 16, 17 are respectively arranged in the two guide tube holes 116, 117 at opposite sides of the nozzle body 11 and extend to a location adjacent to the electrical arc discharging chamber 141 for guiding the metal wires received in the wire guide tubes 16, 17 into the electrical arc discharging chamber 141 for carrying out electrical are discharging.

The nozzle body 11 is preferably made of Bakelite in an integral form. The electrical discharging chamber internal lid 13 is preferably made of Bakelite, while the electrical discharging chamber external cover 14, the nozzle ring 12, and the external mounting ring 15 are preferably made of aluminum alloys.

Since the nozzle ring 12 that is made of aluminum alloy is positioned against the end face of the outlet end 113 of the nozzle body 11 so as to isolate the nozzle body 11 and the electrical arc discharging chamber 141 from each other, whereby the nozzle body 11 is protected against deterioration caused by the heat generated by the electrical arc discharging chamber 141. Further due to the two wire guide tubes 16 being designed for individually replacing the wire emergence terminal 163, 173 that is easy to wear out, the single-air-hole electrical arc spray machine nose 10 is durable and also has a reduced maintenance cost. Further, results of tests reveal tht a sprayed layer of coating formed with an electrical arc spray machine that incorporates the single-air-hole electrical arc spray machine nose 10 has a void ratio that is further lowered down to 0.5%-4.5%, so as to provide a finer sprayed layer of coating.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A nose of single-air-hole electrical arc spray machine, comprising:
a nozzle body, which forms an air flow hole and two guide tube holes that are respectively located at opposite sides of the air flow hole and form a predetermined angle with respect thereto, the air flow hole having an inlet end and an outlet end;
a nozzle ring, which is positioned against and fixed to an end face of the outlet end and forms a through opening corresponding to the air flow hole and the two guide tube holes;
an electrical discharging chamber internal lid, which is positioned against the nozzle ring and forms an internal lid through opening corresponding to the through opening;
an electrical discharging chamber external cover, which is set to cover and enclose the electrical discharging chamber internal lid, whereby the electrical discharging chamber internal lid and the electrical discharging chamber external cover form therebetween an electrical arc discharging chamber;
an external mounting ring, which is coupled to the nozzle ring to mount the electrical discharging chamber internal lid and the electrical discharging chamber external cover to the outlet end of the nozzle body; and
wire guide tubes, which are respectively received in the two guide tube holes to extend to locations adjacent to the electrical arc discharging chamber and are each composed of an insulation section, a conductor section, and a wire emergence terminal that sequentially connected to each other.

2. The nose of single-air-hole electrical arc spray machine according to claim 1, wherein the nozzle body is integrally formed of Bakelite.

3. The nose of single-air-hole electrical arc spray machine according to claim 1, wherein the insulation sections of the wire guide tubes are made of Teflon and the conductor sections and the wire emergence terminals are made of copper.

4. The nose of single-air-hole electrical arc spray machine according to claim 1, wherein the electrical discharging chamber internal lid is made of Bakelite.

5. The nose of single-air-hole electrical arc spray machine according to claim 1, wherein the electrical discharging chamber external cover, the nozzle ring, and the external mounting ring are made of aluminum alloys.

6. The nose of single-air-hole electrical arc spray machine according to claim 1 further comprising an aluminum alloy fixing plate that is fixed to the nozzle body.

7. The nose of single-air-hole electrical arc spray machine according to claim 1, wherein the predetermined angle is between 25 to 35 degrees.
